(19) United States
(12) Patent Application Publication
(10) Pub. No.: US 2009/0039644 A1
(43) Pub. Date: Feb. 12, 2009

(54) Systems and methods for using microscopic capsules containing orientable materials for document security and processing applications

(75) Inventor: Nabil M. Lawandy, Saunderstown, RI (US)

Correspondence Address: K&L Gates LLP, STATE STREET FINANCIAL CENTER, One Lincoln Street, BOSTON, MA, 02111-2950, US

(73) Assignee: Spectra Systems Corporation, Providence, RI (US)

(21) Appl. No.: 12/220,054

(22) Filed: Jul. 21, 2008

Related U.S. Application Data
(60) Provisional application No. 60/961,536, filed on Jul. 20, 2007.

(51) Int. Cl. B42D 15/00; H01F 1/01; B42D 107/00

(52) U.S. Cl. 283/82; 252/62.51 R; 252/62.54; 252/62.53; 252/62.56

(57) ABSTRACT

Systems and methods for using microscopic capsules containing orientable materials for document security and processing applications are presented. A security application comprising a medium having a substrate and a plurality of microcapsules is disclosed. The microcapsules contain magnetically orientable material and a liquid. The magnetically orientable material is oriented in a first alignment. Application of a magnetic field to the medium orients the magnetically orientable material to a second alignment, thereby altering the opacity of the medium. Magnetic material may also be dragged into a concentrated arrangement by a magnetic field, thereby altering the opacity of the medium.

### CROSS-REFERENCE TO RELATED APPLICATIONS

This application claims the benefit of U.S. Provisional Patent Application Ser. No. 60/961,536, filed Jul. 20, 2007, the entire disclosure of which is incorporated by reference herein.

### FIELD OF INVENTION

The invention relates to document security and, more specifically, to the use of capsules containing magnetic materials for document security and processing applications.

### BACKGROUND

Identity theft is one of the greatest concerns in the consumer marketplace. With only a small amount of information about an individual, such as an address and a social security number, even an unskilled thief can forge, counterfeit and fraudulently obtain unauthorized access to a consumer's assets, credit lines, and bank accounts, and obtain other vital private information. Identity theft has become such an epidemic that almost all major credit card companies and banks offer inexpensive credit monitoring services to their customers to provide constant supervision over their assets and credit reports.

Likewise, counterfeiting and forgery have become significant concerns in the modern economy and marketplace. Advances in computing technology and printing techniques have increased the incidence of forgeries, counterfeit documents, and other fraudulent activities. Countless areas of today's high-technology society require and rely upon certification, authentication and protection of highly valuable documents, papers or other materials. Fraudulent activities such as counterfeiting currency and forging signatures or handwriting are common. Methods of creating and perfecting forgeries and counterfeit documents, however, have become easier and more available with the advent of highly skilled computer printing and processing. Since as far back as 1991, the United States Treasury has continually added security safeguard features to the denominations of currency in an attempt to combat the use of counterfeit money. These safeguards have included watermarks, security threads embedded in the paper, microprinting, color-shifting ink, and the use of multi-colored bills.

Authentication of valuable documents or materials affects many facets of the economy. Notary publics use a raised stamp to authenticate notarized documents; drivers' licenses, passports and other photographic identification contain holograms and microprinting; sports memorabilia and retail clothiers use holographic tags and stamps to prove authenticity. Even fashion designers are now including authentication devices in their clothing to prevent passing off of knock-offs as designer products.

Document security and authentication are of paramount importance for a number of applications ranging from stock certificates to passports to currency. Security features that are easily validated by the public, as well as machine readable features, play a role in preventing counterfeiting of documents.

Traditional security applications employ and require the use of labels or materials, the opacity of which is controlled through external stimuli such as light, temperature and electric and magnetic fields. Applications for such materials include the protection of signatures and personal identification numbers. The use of magnetic field switchable optical phenomena in security features has been limited due to the weak nature of magneto-optical processes employed, such as Faraday rotation.

There is a need for a new security and processing application for a class of magnetic media consisting of capsules containing magnetic materials that can be oriented or dragged in the presence of magnetic sources and fields.

### SUMMARY OF THE INVENTION

Embodiments of the invention include systems and methods for using microscopic capsules containing magnetic materials for document security and processing applications.

One embodiment of the invention includes a security application comprising a medium having a substrate and a plurality of microcapsules. The microcapsules contain magnetically orientable material and a liquid. The magnetically orientable material is capable of being oriented in a first alignment. Application of a magnetic field to the medium orients the magnetically orientable material in a second alignment.

Another embodiment of the invention includes a method of authenticating an article by marking the article with a marking and applying a medium over the marking. The medium comprises a substrate and a plurality of microcapsules, which contain magnetically orientable material and liquid. The magnetically orientable material is oriented in a first alignment to obscure the marking. A magnetic field is applied to the medium, thereby orienting the magnetically orientable material to a second alignment and causing the medium to become substantially transparent. The marking is then read to authenticate the article.

Yet another embodiment of the invention includes a method of verifying a marking on an article by disposing a medium on the marking. The medium has a plurality of microcapsules filled with magnetically orientable material and a liquid. The magnetically orientable material is suspended in a random arrangement such that the medium is substantially opaque. A magnetic field is then applied to the medium, dragging the magnetically orientable material within the microcapsule to a concentrated arrangement such that the medium is substantially transparent.

### BRIEF DESCRIPTION OF THE DRAWINGS

These embodiments and other aspects of this invention will be readily apparent from the detailed description below and the appended drawings, which are meant to illustrate and not to limit the invention, and in which:

FIG. 1A depicts an application of a film, in accordance with an embodiment of the present invention, which covers a signature;

FIG. 1B depicts an application of a film covering a signature after a magnetic field is applied;

FIG. 2A depicts a medium in the absence of a magnetic field in accordance with an embodiment of the present invention;

FIG. 2B depicts a medium in the presence of a magnetic field in accordance with an embodiment of the present invention; and

FIG. 3 depicts a medium in the presence of a magnetic field in accordance with an embodiment of the present invention; and

FIG. 4 is a flow diagram of some of the steps of a method of authenticating an article in accordance with an embodiment of the present invention.

### DETAILED DESCRIPTION

The invention will be more completely understood through the following detailed description, which should be read in conjunction with the attached drawings. Detailed embodiments of the invention are disclosed herein, however, it is to be understood that the disclosed embodiments are merely exemplary of the invention, which may be embodied in various forms. Therefore, specific functional details disclosed herein are not to be interpreted as limiting, but merely as a basis for the claims and as a representative basis for teaching one skilled in the art variously to employ the invention in virtually any appropriately detailed embodiment.

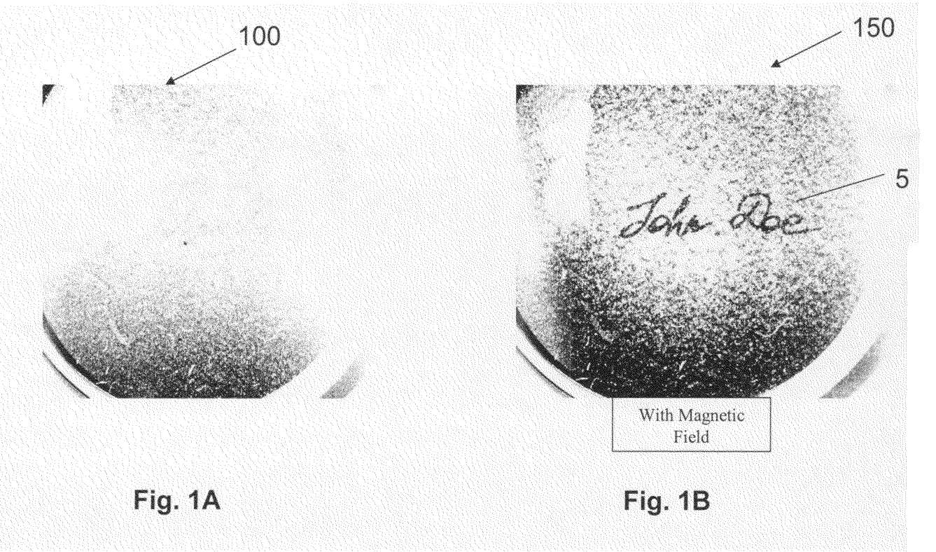

One embodiment of the invention employs the use of labels or materials, the opacity of which is controlled through external stimuli such a magnetic field. FIGS. 1A and 1B show the use of such a film covering a signature until a magnetic field is used to reveal the signature. Prior to the application of a magnetic field, as shown in sample 100 of FIG. 1A, no signature or other markings are visible to the viewer. Upon application of a magnetic field, as shown in sample 150 of FIG. 1B, the previously invisible signature 5 is now visible through the film.

One embodiment of the invention includes a substantially transparent substrate coated with magnetic microcapsules used as a label for covering up a marking, such as a signature or PIN number. The label includes a medium comprised of capsules made of polymeric materials such as pigskin gelatin, gum Arabic and ethylenemaleic anhydride copolymers of different molecular weights. Other polymeric capsule materials compatible with the micro-encapsulation process may be used. According to one embodiment, a liquid such as water and flakes of magnetic material such as nickel or iron oxide are included within the capsule. In the absence of a magnetic field, the encapsulated flakes are randomly oriented and the transmission of a plurality of such microcapsules on a substrate is determined by the reflective and absorptive properties of the flakes in such an orientation. The magnetic material is subject to reorientation either in the plane or perpendicular to the plane of the film, as well as to attractive forces dragging the magnetic material, e.g., by an external magnetic field. The two states provide a sufficient difference in light reflectivity to create visible contrast by addressing the film locally, either on a pixel-by-pixel basis or by spatially patterning the driving magnetic field itself.

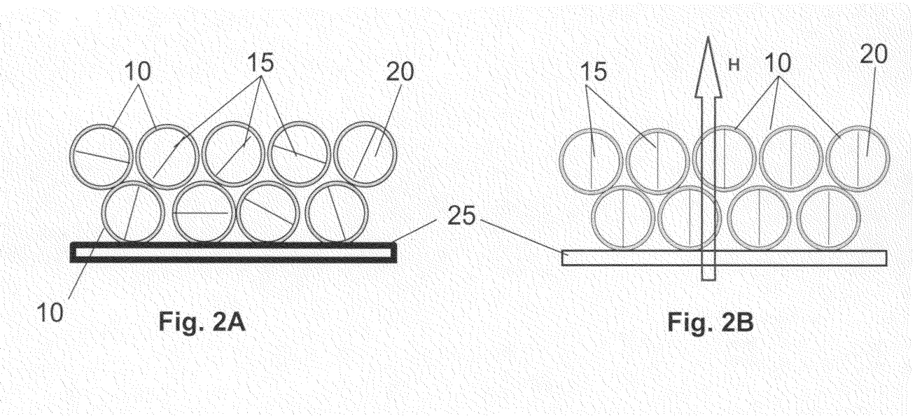

FIG. 2A shows a plurality of layers of microcapsules 10 disposed on a substrate 25 with no applied magnetic field. The microcapsules include magnetically orientable flakes 15 suspended in a liquid 20. The arrangement and alignment of the flakes 15 are random and do not allow a clear view through the substrate the microcapsules, thus impeding the view of any material below the substrate. Upon the application of a magnetic field, the orientation of the flakes 15 is altered, permitting a line of sight through the substrate 20 and microcapsules 10 to the material underneath. FIG. 2B shows the orientation of the flakes 15 inside the microcapsules upon application of a uniform magnetic field (H) pointing upwards from the substrate 20. Each of the flakes 15 is oriented substantially perpendicularly to the substrate 20.

Embodiments of the invention may be utilized as labels for a signature or other authenticating markings. For example, an original document may be signed or executed with a signature or other marking such as a stamp, and a label as described above is applied over the signature or marking. The label obscures the signature until an appropriate magnetic field is applied over the label. When the field is applied, the signature may be viewed and authenticated. The label may be placed or designed in such a manner that only authorized users may know the label has been applied, or where the label has been applied. Authentication of the document may then be restricted to only those with knowledge of the label and how to activate it to view the authenticating marking underneath the label.

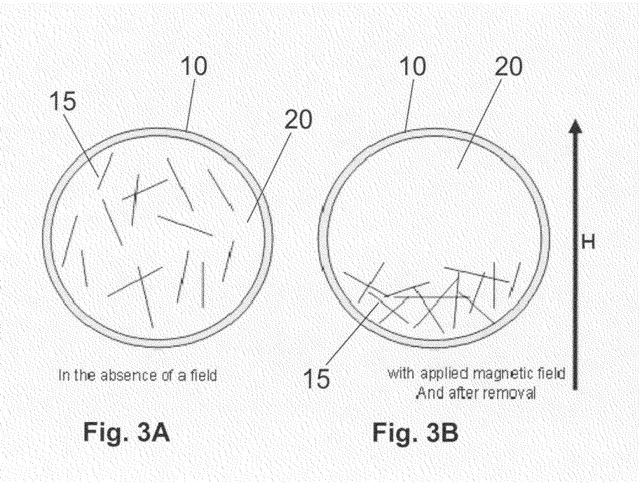

According to one embodiment, the flakes or platelets of magnetic material with in the microcapsules are dragged to the bottom of the microcapsule by the application of a magnetic field to alter the opacity of the microcapsule. As depicted in FIG. 3A, a microcapsule 10 contains a plurality of magnetic flakes 15 suspended in a liquid 20. In the absence of a magnetic field the flakes 15 float in a random arrangement within the microcapsule 10. When a magnetic field (H) is applied, as shown in FIG. 3B, the flakes are dragged to the bottom portion of the microcapsule 10 to a concentrated arrangement. The magnetic material in the concentrated arrangement remains in a random alignment; however, the opacity of the microcapsule is altered substantially allowing light to pass through the microcapsules and to the material below.

According to one embodiment, the use of a material having magnetic microcapsules is employed in a voting application such as a ballot. The ballot may be completed and executed with a voter's signature. The voter may then apply the material over the signature to preserve its authenticity. To verify the signature, a magnetic field is applied to the material, thus altering the arrangement of the magnetic material contained within the microcapsules, either by orienting the materials to be perpendicular to the plane, as shown in FIGS. 2A-B, or by dragging the magnetic materials to a concentrated arrangement, thereby altering the opacity of the microcapsules and the material to show the signature beneath.

Another embodiment of the invention includes the use of the medium to obscure or reveal confidential information. For example, a document or other writing containing confidential information desired to hidden from certain viewers may utilize the label to cover the confidential material. Only those with knowledge and access to the application of a magnetic field can “unlock” the label and view the contents obscured. Further embodiments may utilize such a label to provide security features in automated processing equipment such as a transport for mail or commercial paper such as checks.

Another embodiment of the invention incorporates machine readable information revealed by magnetic field. For example, upon the application of a magnetic field to the medium, a camera system or other optical recognition system may read information previously obscured by the orientation of the materials within the microcapsules. Alternatively, the application of a magnetic field may result in dragging the magnetic material to one portion of a microcapsule to form a machine-readable pattern or code.

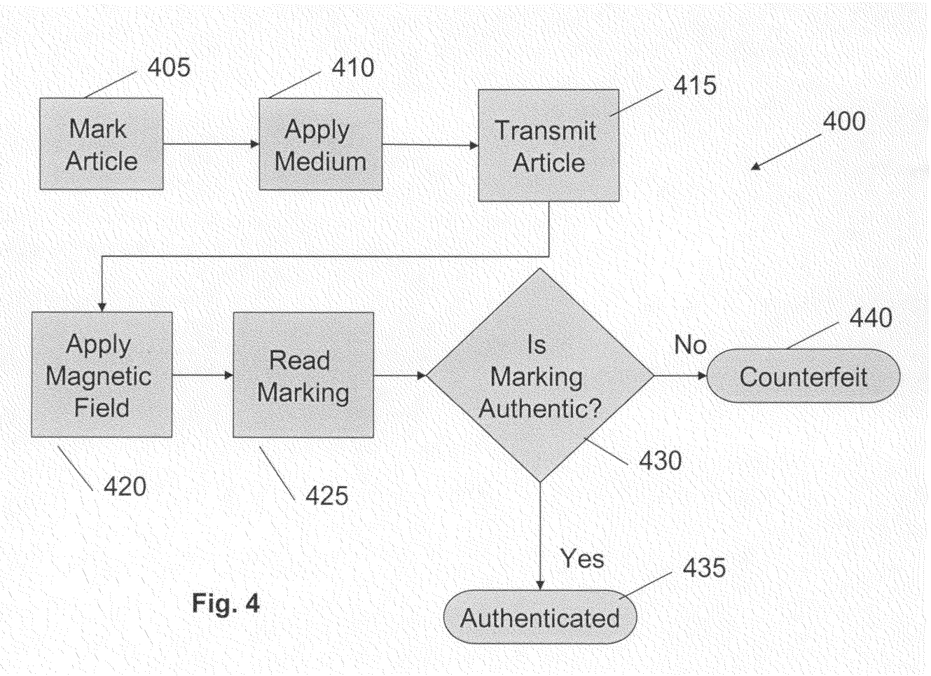

One embodiment of the invention, as shown in the flow chart of FIG. 4, includes a method 400 of authenticating an article using a substrate coated with microcapsules containing magnetically materials. An original or authentic article may be marked with a marking 405, such as a stamp, signature, seal, or other marking. The marking is then covered with a medium 410, such as a label, comprising a substrate coated with a plurality of microcapsules having magnetically materials therein. In a non-magnetized state, the random alignment of the magnetic material within the plurality of microcapsules obscures the marking. The label, in its non-magnetized form, may be an opaque block or another obscuring visual pattern blocking the sight of the marking. The article may then be transported, sold, or otherwise disposed of 415. Should a purchaser or recipient of the article want to ensure or prove the authenticity of the article, a magnetic field may be applied to the label 420. Application of the magnetic field orients the magnetic materials, or drags them into a concentrated arrangement, within the microcapsules such that the obscuring label becomes substantially transparent and the marking can be read below the label 425. The owner or verifier can then determine if the marking and the article are authentic 430. If the expected marking is found below the label, the article is authenticated 435. If the marking is not found, or another marking is seen, the article is not authentic and may be forged, counterfeit or impermissibly altered 440.

Another embodiment includes an ink including microcapsules containing magnetically orientable materials used as a security feature on a document. The ink may be applied to a document, as a stamp, seal, or original writing. Application of the magnetic field to the ink results in a discernable change or pattern in the ink, indicating that the stamp, seal or writing is original and not forged or other wise counterfeit.

Embodiments of the invention also include a security thread coated with or containing magnetic microcapsules. Security threads may be disposed on or embedded into documents, such as currency, to hinder counterfeiting, forgery or other fraudulent actions. When authenticating the currency, the bill is subjected to a magnetic field to reveal or form a designed pattern or marking showing the bill is original and has not been altered. If the application of the field does not give the expected result, the bill may be deemed fake and dealt with appropriately.

Paper or other document substrates may be embedded with magnetic microcapsules to create a magnetic response or a magneto-optical effect, according to further embodiments of the invention.

According to another embodiment of the invention, the magnetic microcapsules are filled with fluorescent liquid or particles in addition to the magnetic materials. The fluorescent magnetic particles emit, diffract and absorb light providing yet another security feature of the medium. Such a configuration may allow the microcapsules to be covertly incorporated into documents or other materials by blending them in with the surrounding colors and materials.

While embodiments of the invention described herein include magnetically orientable flakes, one skilled in the art should recognize that other magnetic materials and shapes (e.g., particles, beads, pellets, nanoparticles, etc.) may be used without deviating from the scope of the invention.

While the invention has been described with reference to illustrative embodiments, it will be understood by those skilled in the art that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A security feature for an article having a marking, comprising:
a medium disposed over the marking, the medium including a plurality of microcapsules comprising magnetically orientable material and a liquid, the magnetically orientable material being oriented in a first alignment such that the marking is obscured;
wherein application of a magnetic field to the medium orients the magnetically orientable material to a second alignment such that the marking is visible.

2. The security feature of claim 1 wherein the second alignment of magnetically orientable material is substantially perpendicular to the article.

3. The security feature of claim 1 wherein the microcapsules comprise copolymers of different molecular weights.

4. The security feature of claim 3 wherein the copolymers are selected from the group consisting of pigskin gelatin, gum Arabic and ethylenemaleic anhydride.

5. The security feature of claim 1 wherein the magnetically orientable material comprises nickel.

6. The security feature of claim 1 wherein the magnetically orientable material comprises iron oxide.

7. The security feature of claim 1 wherein the marking is read by an optical system.

8. The security feature of claim 7 wherein the optical system comprises a camera system.

9. The security feature of claim 7 wherein the optical system comprises an optical character recognition system.

10. The security feature of claim 1 wherein the medium comprises a structure selected from the group consisting of an ink, a paper, and a security thread.

11. The security feature of claim 1 wherein the liquid comprises a fluorescent liquid.

12. The security feature of claim 1 wherein the microcapsules further comprise fluorescent particles.

13. A method of authenticating an article comprising:
disposing a marking on the article;
applying a medium over the marking, the medium including a plurality of microcapsules comprising magnetically orientable material and a liquid, the magnetically orientable material being oriented in a first alignment such that the marking is obscured;
applying a magnetic field to the medium, the magnetic field orienting the magnetically orientable material to a second alignment such that the marking is visible; and
reading the marking to authenticate the article.

14. The method of claim 13 wherein orienting the magnetically orientable material comprises dragging the magnetically orientable material to the bottom of the microcapsule whereby the second alignment forms the marking.

15. The method of claim 13 wherein the marking is read by an optical system.

16. The method of claim 15 wherein the optical system comprises a camera system.

17. The method of claim 15 wherein the optical system comprises an optical character recognition system.

18. The method of claim 13 wherein the liquid comprises a fluorescent liquid.

19. A method of verifying a marking on an article comprising:
disposing a medium on the marking, the medium including a plurality of microcapsules comprising magnetic material and a liquid, the magnetic material suspended in a first arrangement such that the medium is substantially opaque; and
applying a magnetic field to the medium, the magnetic field dragging the magnetic material within the microcapsules to a concentrated arrangement such that the medium is substantially transparent.

20. The method of claim 19 wherein the article is a ballot and the marking is a signature.
